(19) United States
(12) Patent Application Publication
(10) Pub. No.: US 2006/0123108 A1
(43) Pub. Date: Jun. 8, 2006

(54) Embedding a unique identifier in asset information to identify the source of an event

(76) Inventor: Parthasarathy Sarangam, Portland, OR (US)

Correspondence Address: INTEL CORPORATION, P.O. BOX 5326, SANTA CLARA, CA, 95056-5326, US

(21) Appl. No.: 11/008,590

(22) Filed: Dec. 8, 2004

(51) Int. Cl. G06F 15/173

(52) U.S. Cl. 709/224; 709/223

(57) ABSTRACT

In one embodiment, a method is provided. The method of this embodiment provides receiving an indication of one or more events generated by a component, creating an alert of the one or more events, the alert including a unique identifier, and transmitting the alert. Other embodiments are also disclosed.

### FIELD

Embodiments of this invention relate to embedding a unique identifier in asset information to identify the source of an event.

### BACKGROUND

Identifying the source of an event within a system can be a tedious task. For example, when a component on a system generates an error, the system may alert a managing system of such error. While the managing system may know that the alert came from the particular system, this may not be enough information to assist the managing system in determining what component or components are actually failing or causing problems on the system.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a network according to an embodiment.

FIG. 2 illustrates a client and server according to an embodiment.

FIG. 3 illustrates an example client system according to an embodiment.

FIG. 4 is a flowchart illustrating a method according to an embodiment.

FIG. 5 is a flowchart illustrating a method according to another embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

Embodiments of the present invention may be provided, for example, as a computer program product which may include one or more machine-accessible media having machine-executable instructions that, when executed by one or more machines such as a computer, network of computers, or other electronic devices, may result in the one or more machines carrying out operations in accordance with embodiments of the present invention. A machine-accessible medium may include, but is not limited to, floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable media suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

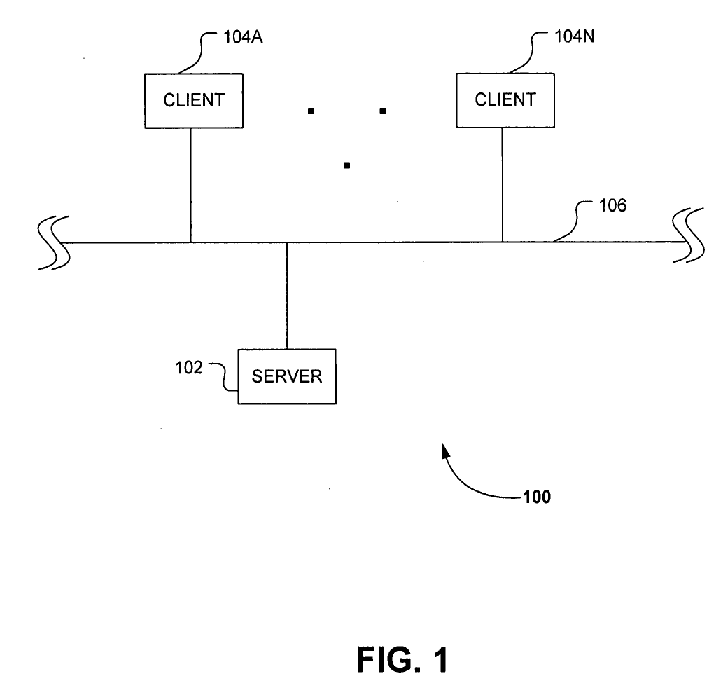

FIG. 1 illustrates a network 100 in accordance with embodiments of the invention. Network 100 may comprise a server 102 and one or more clients 104A, . . . , 104N. Examples of networks include a LAN (local area network), WAN (wide area network), or intranet. Server 102 and clients 104A, . . . , 104N may be communicatively coupled together via a communication medium 106. As used herein, components that are “communicatively coupled” means that the components may be capable of communicating with each other via wirelined (e.g., copper wires), or wireless (e.g., radio frequency) means. As used herein, a “communication medium” means a physical entity through which electromagnetic radiation may be transmitted and/or received. Communication medium 106 may comprise, for example, one or more optical and/or electrical cables, although many alternatives are possible. For example, communication medium 106 may comprise, for example, air and/or vacuum, through which server 102 and one or more clients 104A, . . . , 104N may wirelessly transmit and/or receive sets of one or more signals.

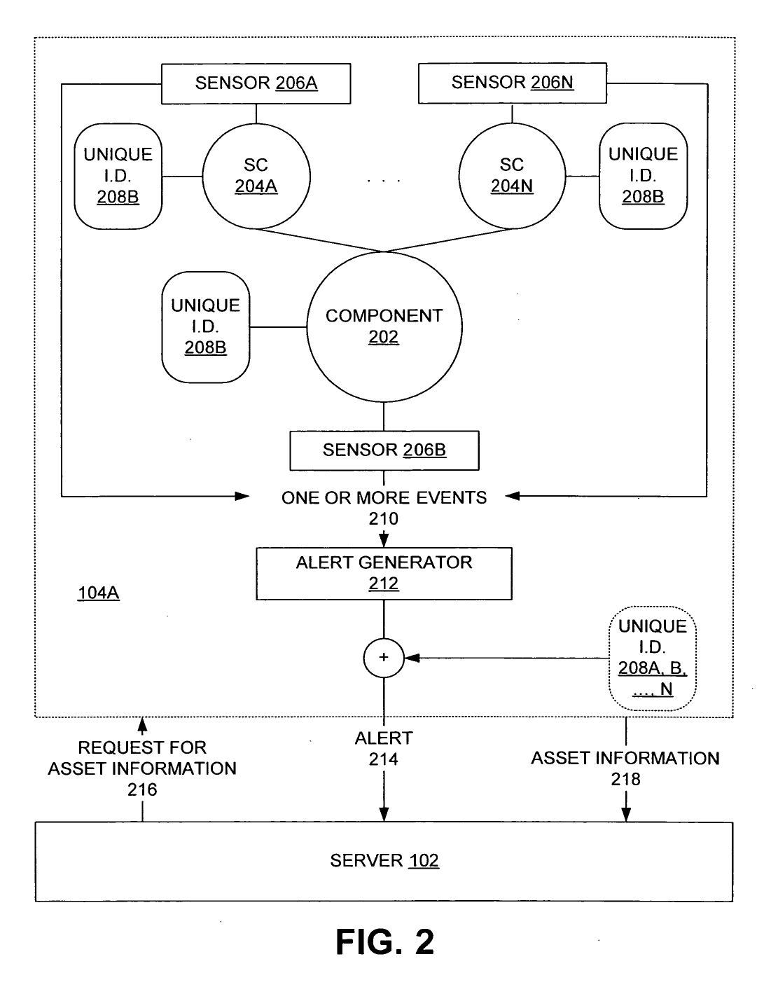

In an embodiment, server 102 may be a management server, and any of one or more clients 104A, . . . , 104N, for example 104A, may be managed clients. Management server may include applications for managing one or more managed clients, and managed client may be managed by a management server to perform tasks such as error recovery, software updates, and inventory queries. As illustrated in FIG. 2, client 104A may comprise one or more components 202 (only one shown) and/or subcomponents (“SC”) 204A, . . . , 204N. As used herein, a “component” and “subcomponent” each refer to a resource on a system for computing. For example, a component may include a disk array, or a network switch, and a subcomponent may include a disk drive on a disk array, such as a RAID (Redundant Array of Independent disks) array. A RAID array may provide two or more disk drives for fault tolerance. Unless otherwise specified, components and subcomponents shall hereinafter be collectively referred to as components.

Each component 202, 204A, . . . , 204N may be associated with a unique identifier 208A, 208B, . . . ,208N, where the unique identifier 208A, 208B, . . . , 208N may be used to uniquely identify the component 202, 204A, . . . , 204N. Each component 202, 204A, . . . , 204N may additionally comprise a sensor 206A, 206B, . . . , 206N. Sensor 206A, 206B, . . . , 206N may comprise hardware and/or software to detect one or more events associated with a component 202, 204A, . . . , 204N. In an embodiment, an event refers to an occurrence of one or more activities that may occur on a component 202, 204A, . . . , 204N. For example, sensor 206A, 206B, . . . , 206N may comprise a temperature sensor to detect events such as overheating of a disk or fan failure; or a program to detect checksum errors. In an embodiment, upon detection of one or more events 210 by a sensor 206A, 206B, . . . , 206N, an alert 214 of the one or more events 210 may be generated by alert generator 212. In an embodiment, alert 214 of one or more events 210 may include a unique identifier 208A, 208B, . . . , 208N that may be transmitted to server 102, where the unique identifier 208A, 208B, . . . , 208N may correspond to a component from which the one or more events 210 of the alert 214 were detected by a corresponding sensor 206A, 206B, . . . , 206N.

In an embodiment, management server, such as server 102, may send a request for asset information 216 to client 104A, and client 104A may respond to server 102 with asset information 218. As used herein, “asset information” refers to data about a system's hardware, software, and/or firmware. For example, asset information may include an inventory of system 200 components 202, 204A, . . . , 204N. Client 104A may return asset information 218 by providing a list of one or more components 202, 204A, . . . , 204N to server 102.

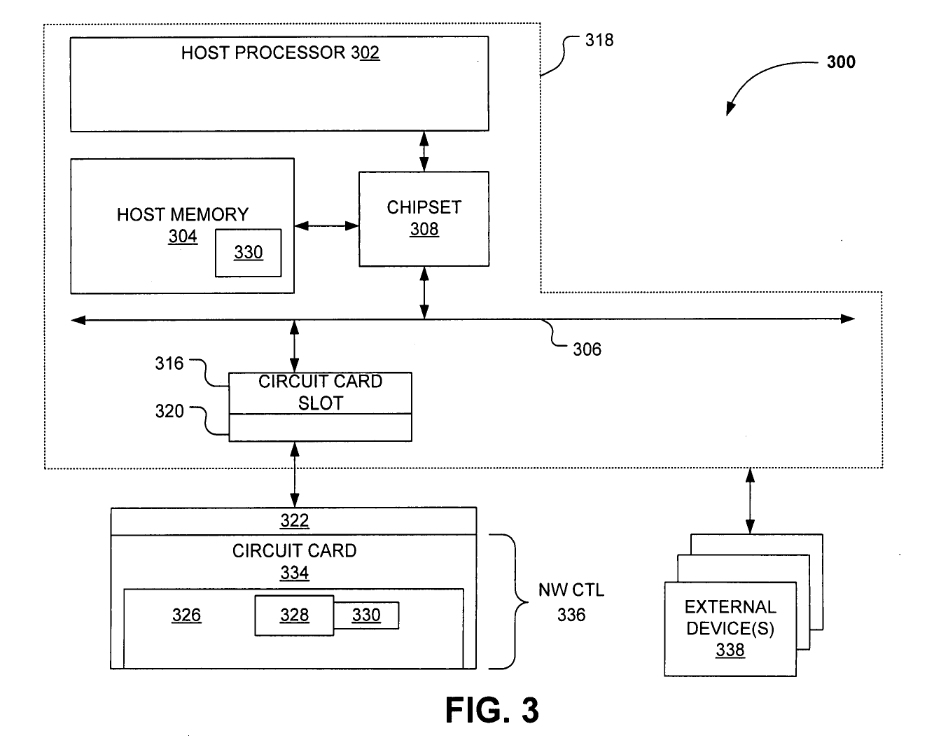

In an embodiment, client 104A, . . . , 104N may comprise a system as illustrated in FIG. 3. System 300 may comprise components, including host processor 302, chipset 308, bus 306, host memory 304, and network controller (“NW CTL”) 336. System 300 may comprise more than one, and other types of processors, memories, buses, and chipsets; however, these are illustrated for simplicity of discussion. System 300 may comprise other components, such as one or more external devices 338. An external device may comprise, for example, external storage, such as a disk array.

System 300, including any of components 202, 204A, . . . , 204N, for example, network controller 336, may comprise circuitry 326 to perform one or more operations described herein. For example, circuitry 326 may comprise one or more digital circuits, one or more analog circuits, one or more state machines, programmable circuitry, and/or one or more ASIC's (Application-Specific Integrated Circuits). Alternatively, and/or additionally, these operations may be embodied in programs that may perform functions described herein. For example, circuitry 326 may comprise computer-readable memory 328 having read only and/or random access memory that may store program instructions 330 that may be executed to perform these operations.

Network controller 336 may be comprised in a circuit card 334 that may be inserted into a circuit card slot 316. For example, network controller 336 may comprise a network interface card (“NIC”). When circuit card 324 is inserted into circuit card slot 316, PCI bus connector 320 on circuit card slot 316 may become electrically and mechanically coupled to PCI bus connector 322 on circuit card 334. When these PCI bus connectors 320, 322 are so coupled to each other, circuitry 326 may become electrically coupled to bus 306. When circuitry 326 is electrically coupled to bus 306, host processor 302 may exchange data and/or commands with circuitry 326 via bus 306 that may permit host processor 302 to control and/or monitor the operation of circuitry 326. In one or more alternative embodiments, network controller 336 may instead be comprised in a single circuit board, such as, for example, a system motherboard 318, or in a chipset, such as chipset 308.

Host processor 302 may comprise, for example, an Intel® Pentium® microprocessor that is commercially available from the Assignee of the subject application. Of course, alternatively, host processor 302 may comprise another type of microprocessor, such as, for example, a microprocessor that is manufactured and/or commercially available from a source other than the Assignee of the subject application, without departing from this embodiment.

Chipset 308 may comprise a host bridge/hub system that may couple host processor 302, and host memory 304 to each other and to bus 306. For example, chipset 308 may comprise I/O (input/output) chipset or a memory chipset. Alternatively, host processor 302, host memory 304, and/or circuitry 326 may be coupled directly to bus 306, rather than via chipset 308. Chipset 308 may comprise one or more integrated circuit chips, such as those selected from integrated circuit chipsets commercially available from the Assignee of the subject application (e.g., graphics, memory, and I/O controller hub chipsets), although other one or more integrated circuit chips may also, or alternatively, be used.

Bus 306 may comprise a bus that complies with the PCI-X Specification Rev. 1.0a, Jul. 24, 2000, (hereinafter referred “PCI-X bus”), or a bus that complies with the PCI-E Specification Rev. PCI-E (hereinafter referred to as a “PCI-E bus”), as specified in “The PCI Express Base Specification of the PCI Special Interest Group”, Revision 1.0a, both available from the PCI Special Interest Group, Portland, Oreg., U.S.A. Alternatively, bus 306 may comprise a bus that complies with the System Management (SM) Bus Specification, Version 2.0, Aug. 3, 2000 (hereinafter “SM Bus”). Bus 306 may comprise other types and configurations of bus systems.

System 300 may comprise one or more memories to store machine-executable instructions 330 capable of being executed, and/or data capable of being accessed, operated upon, and/or manipulated by circuitry, such as circuitry 326. For example, these one or more memories may include host memory 304, and/or memory 328. One or more memories 304 and/or 328 may, for example, comprise read only, mass storage, random access computer-accessible memory, and/or one or more other types of machine-accessible memories. The execution of program instructions 330 and/or the accessing, operation upon, and/or manipulation of this data by circuitry 326 may result in, for example, system 300 and/or circuitry 326 carrying out some or all of the operations described herein.

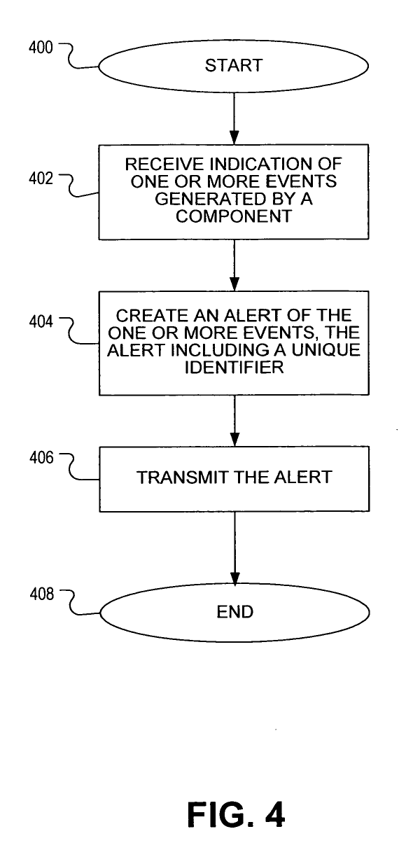

FIG. 4 is a flowchart illustrating a method according to an embodiment. The method begins at block 400 and continues to block 402 where an indication of one or more events 210 generated by a component 202, 204A, . . . , 204N may be received. In an embodiment, indication of an event 210 may be received from a sensor 206A, 206B, . . . , 206N associated with the component 202, 204A, . . . , 204N.

At block 404, an alert 214 of the event 210 may be generated, the alert 214 including a unique identifier 208A, 208B, . . . , 208N. In an embodiment, unique identifier 208A, 208B, . . . , 208N may be generated in response to server's 102 request for asset information 216. In an embodiment, server 102 may query client 104 for asset information 218, or may wait for asset information 218 from client 104A, such as in accordance with a schedule. In an embodiment, client 104A may return asset information 218 by providing a list of one or more components 202, 204A, . . . , 204N to server 102. For each component 202, 204A, . . . , 204N that client 104A returns, server 102 may create an entry in a database, and attach a unique identifier 208A, 208B, . . . , 208N to the component 202, 204A, . . . , 204N. Entry in database may match be based, at least in part, on unique identifier 208A, 208B, . . . , 208N. For example, entry may match unique identifier 208A, 208B, . . . , 208N, or may be a function of unique identifier 208A, 208B, . . . , 208N. Of course, other possibilities exist without departing from embodiments of the invention.

Unique identifier 208A, 208B, . . . , 208N may be generated by client 104A, or by server 102. For example, unique identifier 208A, 208B, . . . , 208N may be generated by component 202, 204A, . . . , 204N on client 104A,. As another example, unique identifier 208A, 208B, . . . , 208N may instead be generated by server 102. In the latter embodiment, server 102 may generate unique identifier 208A, 208B, . . . , 208N for each component 202, 204A, . . . , 204N, and return unique identifier 208A, 208B, . . . , 208N to client 104A. Client 104A may then use a corresponding unique identifier 208A, 208B, . . . ,208N to generate alert 214. Embodiments of the invention are not limited by such examples, however.

At block 406, the alert 214 may be transmitted. In an embodiment, the alert 214 may be transmitted to server 102, where server may use unique identifier 208A, 208B, . . . , 208N to correlate the one or more events 210 to a component 202, 204A, . . . , 204N.

At block 408, the method of FIG. 4 may end. In an embodiment, an indication of one or more events 210 generated by a component 202, 204A, 204N may be detected by and received from a sensor 206A, 206B, . . . , 206N associated with the component 202, 204A, . . . , 204N. Component 202, 204A, . . . , 204N or sensor 206A, 206B, . . . , 206N may notify an alert generator 212 of one or more events 201, and may generate an alert 214. In an embodiment, alert generator 212 may comprise a firmware module on network controller 336. Other possibilities exist. For example, firmware module may be comprised on a chipset, such as chipset 308, or on a processor such as host processor 302. Still in other embodiments, alert generator 212 may comprise the sensor 206A, 206B,. . . , 206N itself, or some other device on system, such as a modem, or a pager (not shown). Alert 214 may be transmitted to server 102 by, for example, network controller 336.

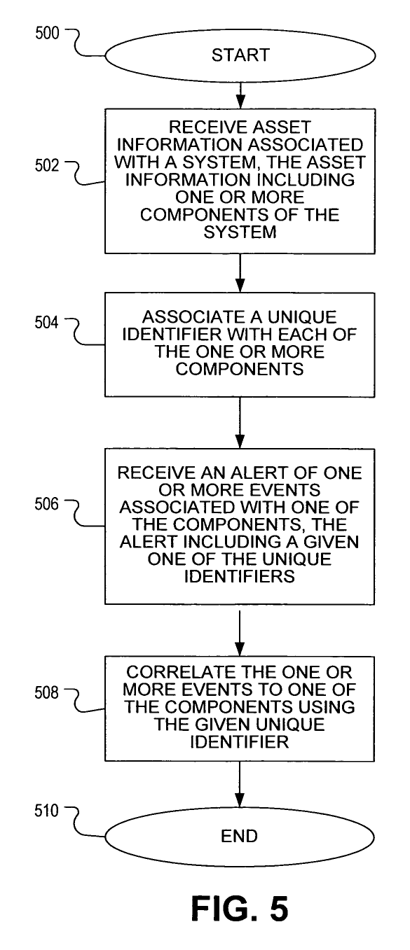

FIG. 5 illustrates a flowchart in accordance with another embodiment of the invention. The method begins at block 500 and continues to block 502 where asset information 218 associated with a system 300 may be received, where the asset information 218 may comprise one or more components 202, 204A, . . . , 204N of the system.

At block 504, a unique identifier 208A, 208B, . . . , 208N may be associated with each component 202, 204A, . . . , 204N. A unique identifier 208A, 208B, . . . , 208N may be associated with each component 202, 204A, . . . , 204N by creating a database having one or more entries, where each entry includes a component 202, 204A, . . . , 204N and a corresponding unique identifier 208A, 208B, . . . 208N.

At block 506, an alert 214 of the one or more events associated with one of the components may be received, the alert 214 including a given one of the unique identifiers 208A, 208B, . . . , 208N.

At block 508, the one or more events 210 may be correlated to one of the components 202, 204A, . . . , 204N using the given unique identifier 208A, 208B, . . . , 208N. In an embodiment, server 102 may use the unique identifier 208A, 208B, . . . , 208N associated with the alert 214 to find an entry in the database. For example, unique identifier 208A, 208B, . . . , 208N may be matched to an entry in database, or a function may be performed over unique identifier 208A, 208B, . . . , 208N to derive at entry in database. Server 102 may then read the corresponding database entry to find the component 202, 204A, . . . , 208N from which the one or more events 210 of the alert 214 was generated.

At block 510, the method of FIG. 5 may end. In an embodiment, a management server, such as server 102, may perform the method of FIG. 5.

In an alternative embodiment, client 104A, . . . , 104N may comprise a system such as a cluster. A cluster refers to a group of components for computing. For example, a cluster may comprise servers and network switches as part of its system, where each server, and each network may be a component of the system. Other systems having components are envisioned by embodiments of the invention.

Conclusion

Therefore, in one embodiment, a method may comprise receiving an indication of one or more events generated by a component, creating an alert of the one or more events, the alert including a unique identifier, and transmitting the alert.

Embodiments of the invention may enable events, such as errors, to be correlated with the source of those events. By attaching a unique identifier to asset information, such as components in a system, errors that are generated by specific components may be associated with the unique identifier so that the errors can be correlated back to the components. Consequently, systems, such as management systems, may be able to identify components on a system that are causing failures and/or problems. Also, by identifying a particular component in error, a management system may be able to analyze the risk at hand. For example, if a disk drive in a RAID array fails, then the management server may ignore the error since the RAID array provides redundancy. On the other hand, if the component is identified as a boot disk, for example, then the management server may know that the risk at hand is high, and may take action.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
receiving an indication of one or more events generated by a component;
creating an alert of the one or more events, the alert including a unique identifier; and
transmitting the alert.

2. The method of claim 1, wherein the unique identifier is generated by a management server.

3. The method of claim 2, wherein the unique identifier is generated by the management server in response to receiving asset information from a system on which the component resides.

4. The method of claim 1, wherein the one or more events comprise an indication of error.

5. A method comprising:
receiving asset information associated with a system, the asset information including one or more components of the system;
associating a unique identifier with each of the one or more components;
receiving an alert of one or more events associated with one of the components, the alert including a given one of the unique identifiers; and
correlating the one or more events to one of the components using the given unique identifier.

6. The method of claim 5, wherein the corresponding unique identifier is received with the asset information.

7. The method of claim 6, wherein said associating a unique identifier with each of the one or more components comprises for a given component:
creating an entry in a database, wherein the entry comprises the given component and a corresponding unique identifier.

8. The method of claim 7, wherein said correlating the one or more events to one of the components using the given unique identifier comprises:
finding to an entry in the database using the given unique identifier, and reading the corresponding component from the entry.

9. An apparatus comprising:
circuitry capable of:
receiving an indication of one or more events generated by a component;
creating an alert of the one or more events, the alert including a unique identifier; and
transmitting the alert.

10. The apparatus of claim 9, wherein the unique identifier is generated by a management server.

11. The apparatus of claim 10, wherein the unique identifier is generated by the management server in response to receiving asset information from a system on which the component resides.

12. The apparatus of claim 9, wherein the one or more events comprise an indication of an error.

13. A system comprising:
a circuit board having a circuit card slot; and
a circuit card coupled to the circuit board via the circuit card slot, the circuit card operable to:
receive an indication of one or more events generated by a component;
create an alert of the one or more events, the alert including a unique identifier; and
transmit the alert.

14. The system of claim 13, wherein the unique identifier is generated by a management server.

15. The system of claim 14, wherein the unique identifier is generated by the management server in response to receiving asset information from a system on which the component is located.

16. The system of claim 13, wherein the one or more events comprise an indication of an error.

17. An article comprising a machine-readable medium having machine-accessible instructions, the instructions when executed by a machine, result in the following:
receiving an indication of one or more events generated by a component;
creating an alert of the one or more events, the alert including a unique identifier; and
transmitting the alert.

18. The article of claim 17, wherein the unique identifier is generated by a management server.

19. The article of claim 18, wherein the unique identifier is generated by the management server in response to receiving asset information from a system on which the component is located.

20. The article of claim 17, wherein the one or more events comprise an indication of an error.
